(19) United States
(12) Patent Application Publication
(10) Pub. No.: US 2007/0240584 A1
(43) Pub. Date: Oct. 18, 2007

(54) Method for operating a calendar machine for plastic melts

(76) Inventor: Bernhard Lucas, RIELASINGEN-WORBLINGEN (DE)

Correspondence Address: BACHMAN & LAPOINTE, P.C., 900 CHAPEL STREET, SUITE 1201, NEW HAVEN, CT, 06510, US

(21) Appl. No.: 11/632,016

(22) PCT Filed: Feb. 25, 2005
(86) PCT No.: PCT/EP05/02030

§ 371 Date: Feb. 5, 2007

(30) Foreign Application Priority Data
Jul. 8, 2004 (DE) 10 2004 033 234.7

(51) Int. Cl. B30B 3/04

(52) U.S. Cl. 100/161; 100/167

(57) ABSTRACT

A method and a device for operating a calendar machine for plastic melts, the machine comprising a downstream roll conveyor, the position of the roll conveyor being oriented in relation to a position of a roll of the calendar machine.

### BACKGROUND OF THE INVENTION

The present invention relates to a process for operating a smoothing calender for plastic melts with a succeeding roller conveyor together with a device for carrying out the process.

In the case of conventional processes, a roller conveyor is positioned securely below the conventional smoothing calender when processing plastic melts to carry away completed plates of plastic or the like, this conveyor being opposite a last roll of a smoothing calender and securely aligned with it.

Hence, it is disadvantageous that it is not possible to set a release point for the completed plate from the last roll of the smoothing calender to the first roll of the roller conveyor and as a result of this it is often necessary during operation to allow for delays, a higher wear rate of material and manual intervention to ensure that the product which leaves the last roll of the smoothing calender transfers to the roller conveyor.

It is also disadvantageous that, particularly in the event of a crash, the melt impacts upon the roller conveyor, which is equally undesirable.

U.S. Pat. No. 4,784,596 describes a calender installation for the production of thermoplastic melts, in which an embossing device which can move on a carriage and has three rolls is connected downstream of a smoothing calender. The embossing device can be moved horizontally over the carriage.

Patent Abstracts of Japan, Vol. 13, No. 214, May 18, 1989 and JP 01 031609 A discloses a smoothing calender with a stretching unit connected downstream of it. The stretching unit can be vertically displaced onto different rolls of the smoothing calender.

U.S. Pat. No. 4,408,974 discloses a stretching unit which is connected downstream of the smoothing calender and can be displaced horizontally on a carriage. The height of individual rolls can be adjusted in order for the web that is to be stretched to be introduced.

DE 19 82 080 U likewise describes a calender with downstream stretching unit, which can be displaced horizontally on a carriage.

The object of the present invention lies, therefore, in creating both a process and a device for carrying out the process by means of which a production sequence for processing plastic melts by smoothing calenders and roller conveyors independent of material, thickness or temperature can be optimized without any requirement for manual intervention and nevertheless, a multiplicity of products and plates of different thicknesses can be produced. Furthermore, operational safety is to be increased and the speed of production is to be increased, where the quality of the product produced is also to be considerably improved.

### SUMMARY OF THE INVENTION

The object is achieved by providing a process for operating a smoothing calender for plastic melts with a downstream roller conveyor, characterized in that a position of the roller conveyor is aligned upon a position of a roll (4) of the smoothing calender. The object is further achieved by providing a device to operate a smoothing calender for plastic melts with a downstream roller conveyor, characterized in that the roller conveyor can be driven to a position of a roll (4) of the smoothing calender.

In the case of the present invention, it has proven to be particularly advantageous for a roller conveyor opposite a last roll of any smoothing calender to run in a controlled and actuable manner in an x- and/or y-direction during operation in order to permanently align a position of the first roll in a roller conveyor with respect to a last roll of the smoothing calender, to accommodate a separation distance, to justify a separation distance and finely adjust a separation distance. This can be advantageous for different processes in the course of operation, i.e. for the starting-up process, for the process of positioning the rolls of the smoothing calender and also for the production process.

In the course of operation, it has also proved to be particularly advantageous in the case of varying parameters such as changing thickness, changing exit temperatures to continuously adjust or set a separation distance between a first roll of the roller conveyor and the last roll of the smoothing calender.

In that context, the first roll of the roller conveyor is to be understood as meaning that roll which meets the plastic melt processed in the smoothing calender for example to form the plastic plate.

To this end, the roller conveyor can be kept continuously in operation in an x- and/or a y-direction by any preferred driving agents, driving cylinders, hydraulic cylinders, servo-motors, linear motors or the like. One possibility to be considered is to propel the roller conveyor with respect to a frame in an illustrated x- and/or y-direction in an actively controlled manner in order to establish a separation distance from a first roll of the roller conveyor with respect to a last roll of any smoothing calender.

Either the smoothing calender and/or the roller conveyor may also be provided with appropriate distance-measuring devices—preferably close to the last roll of the smoothing calender or preferably close to the first roll of the roller conveyor—which distance-measuring devices, in addition to measuring, adjusting or checking the determined positions of the roller conveyor in the x- and/or y-direction, also continuously measure the distance between the two rolls. This is also to lie within the framework of the present invention.

It has, therefore, proven to be specially advantageous that, in particular, the task of starting up a production process in which a plastic melt fed from an extruder or through a broad-slit nozzle and led both to and through the smoothing calender is made less difficult. In that respect, when the processed plastic melt is fed out from the last roll of the smoothing calender, a transfer onto a first roll of a roller conveyor is made much less difficult, since the release point of the completed plate to the first roll of the roller conveyor can be adjusted precisely by positioning the roller conveyor. Manual intervention is no longer necessary; a start-up process can take place automatically.

Furthermore, it is then possible in the start-up process and particularly in the positioning process for the smoothing calender to set a correspondingly required desired thickness of the plastic plate and also continuously during operation to carry the first roll of the roller conveyor in the method described above towards the last roll of the smoothing calender, which also moves. In this way, higher speeds of production or of starting-up can be undertaken while maintaining the quality of the product.

In addition, it is guaranteed that in a crash, relative to a background, the roller conveyor can be very quickly lowered at a very high speed so that no melt impacts with the roller conveyor or damages the rolls of the smoothing calender.

A greater opening speed of the roller conveyor relative to the smoothing calender and, in particular, the last roll of the smoothing calender makes it possible, even in an “emergency stop” situation to effect a rapid shutdown without resulting damage.

### BRIEF DESCRIPTION OF THE DRAWINGS

Further advantages, characteristic features and individual characteristics of the invention are to be found in both the following description of preferred exemplary embodiments and the drawing; in which

FIG. 1a shows a schematically-represented side elevation of a device according to the invention for operating a smoothing calender for plastic melts with a downstream roller conveyor in a start position;

FIG. 1b shows a schematically-represented side elevation of the device according to FIG. 1a in a working position;

FIG. 1c shows a schematically-represented side elevation of the device according to FIG. 1a in production;

FIG. 2a shows a schematically-represented side elevation of a further exemplary embodiment of a device for operating a smoothing calender for plastic melts with a downstream roller conveyor in a start position;

FIG. 2b shows a schematically-represented side elevation of the device according to FIG. 2a in a start position;

FIG. 2c shows a schematically-represented side elevation of the device according to FIG. 2a in production;

FIG. 2d shows a schematically-represented side elevation of the device with lowered roller conveyor in the emergency- or servicing operation.

### DETAILED DESCRIPTION

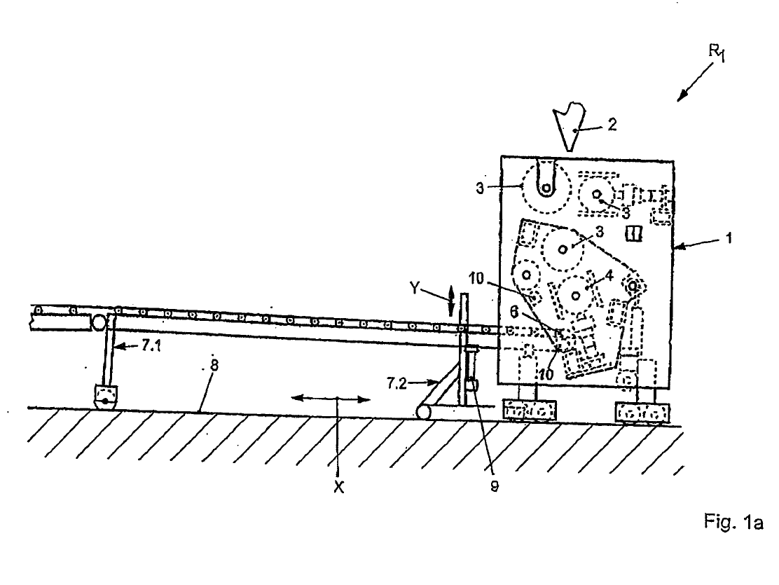

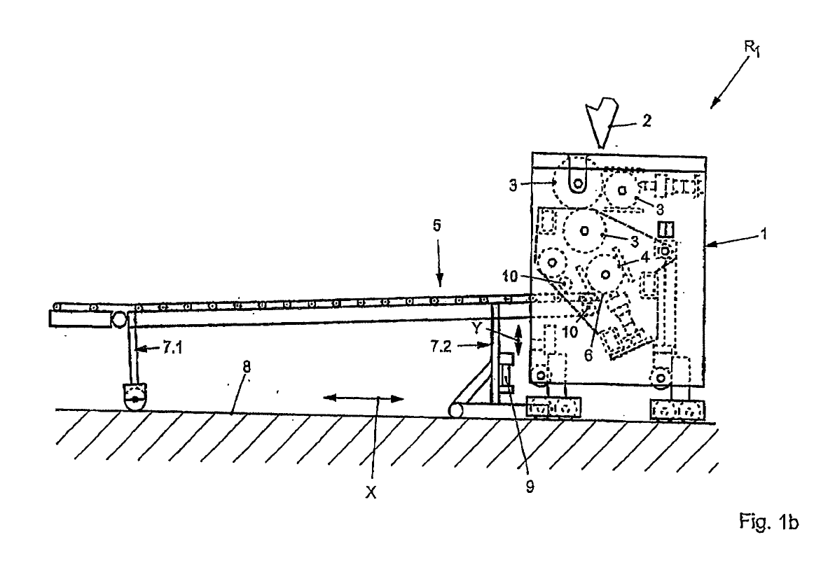

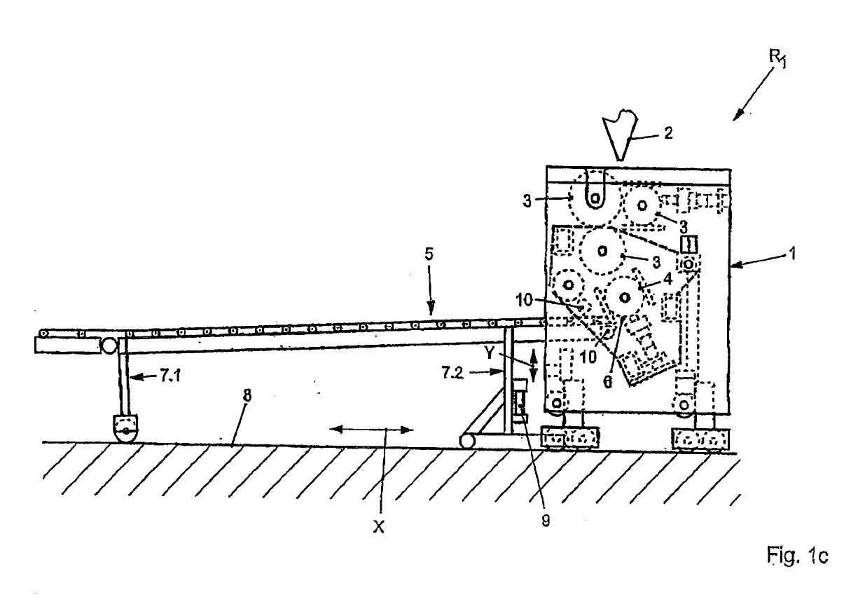

According to FIG. 1a, a device R₁ according to the invention comprises a smoothing calender 1 into which a broad-slit nozzle 2 supplies an extruded plastic melt between the individual rolls 3 of the smoothing calender 1, which bring it to a desired thickness while simultaneously cooling it over the rolls 3 and the last roll 4. Having arrived at the last roll 4 of the smoothing calender 1, the completed plastic plate, film or the like then passes to a roller conveyor 5 or, as can be seen from the FIGS. 1b and 1c, is transferred from the last roll 4 of the smoothing calender 1 to a first roll 6 of the roller conveyor 5 in order then for the manufactured products, for example to be completely cooled on the roller conveyor 5, to be homogenized and then to pass on to a further processing stage such as, for example, a lengthening device, a wind-up device or the like.

In the case of the present invention, the smoothing calender 1 can be constructed as illustrated as a four-roll smoothing calender but also as a three-roll version or a differently configured smoothing calender. The only important consideration is that the last roll 4 of a preferred smoothing calender 1 transfers the reshaped plastic melt to the roller conveyor 5, and, in particular, to a first roll 6.

Furthermore, in the case of the present invention, it has proven to be particularly advantageous that the roller conveyor can travel backwards and forwards over at least one frame 7.1, 7.2 in an illustrated x-direction, where the frame 7 is in a fixed position relative to a background 8 or is even guided linearly.

The roller conveyor 5 can be moved backwards and forwards exactly and very precisely in the illustrated double-arrow direction x by suitable drive elements 9 or drive agents not shown in detail.

In that respect, an additional drive element 9 is assigned to the frame 7.2 which is preferably arranged and aligned close to the smoothing calender 1 in order to move the roller conveyor 5 backwards and forwards in an illustrated y-direction.

This involves the roller conveyor 5 and, in particular, the frames 7.1 or 7.2 being connected to a path-measurement system in order to determine an exact position in the x- or y-direction continuously, even during operation.

In this way the present invention makes it possible for the preferably the first roll 6 of the roller conveyor 5 to be positioned exactly by reference to the last roll 4 of the smoothing calender 1 so that, as illustrated, for example, in FIG. 1a, a transfer of the reshaped plastic material or the plastic melt treated in the smoothing calender 1 takes place without the expenditure of additional manual effort.

In the exemplary embodiment according to FIG. 1b it is then illustrated how the roller conveyor 5, in particular, the first roll 6 is driven close underneath the last roll 4 of the smoothing calender 1.

In FIG. 1c it is shown how the smoothing calender 4 is closed and continuously processes the plastic melt in operation and constantly effects transfer to the roller conveyor 5.

In operation, this involves making a continuous comparison and measurement of a separation distance between the first roll 6 of the roller conveyor 5 and roll 4, where corresponding distance-measuring devices 10 which are only indicated here can also be assigned to the smoothing calender 1 and/or the roller conveyor 5. Preferably these are provided close to the roll 6 and they ensure that a separation distance between the first roll 6 of the roller conveyor 5 and the last roll 4 of the smoothing calender 1 is continuously set and is adapted or moved during operation in the event of charging production conditions, i.e. variation in speed, change in thickness, change in the output temperature of the material.

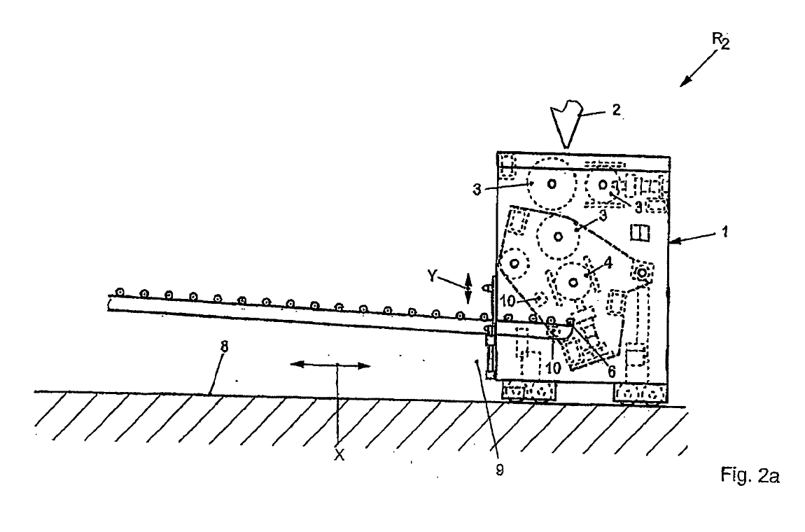

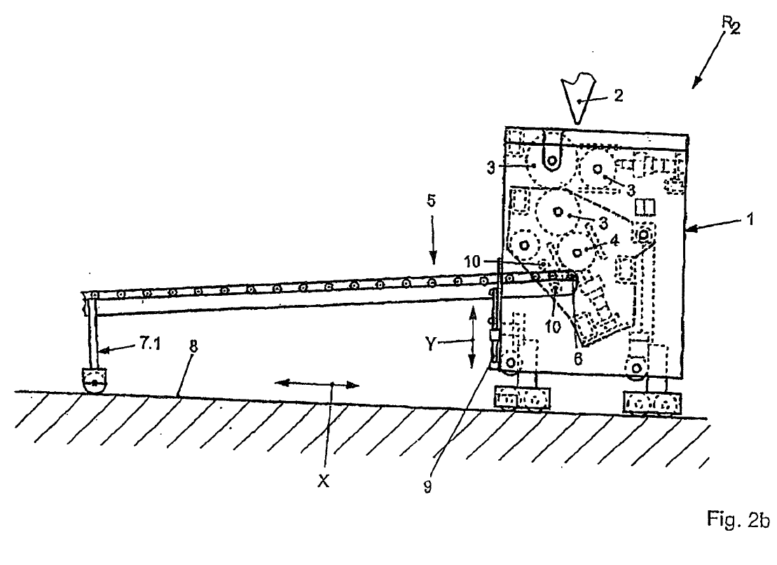

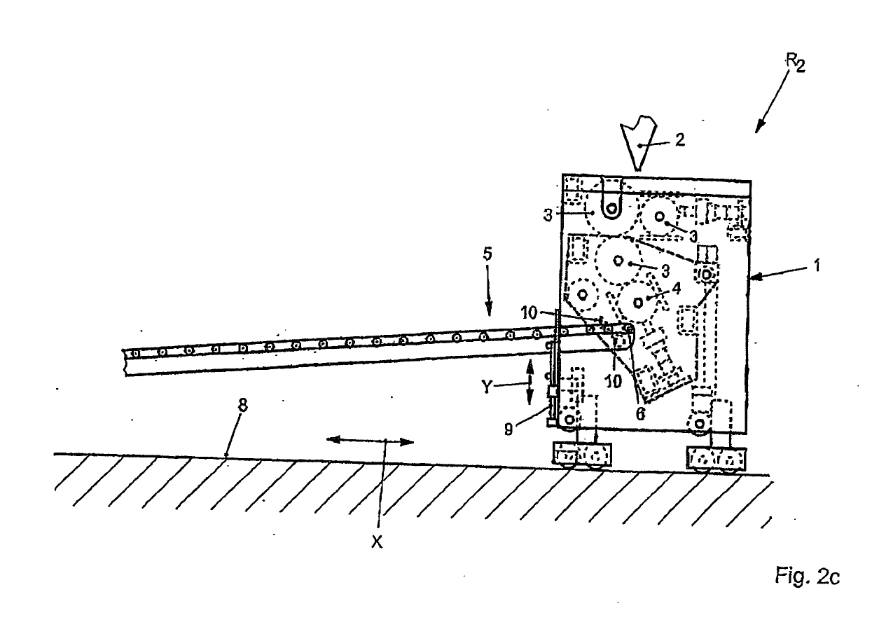

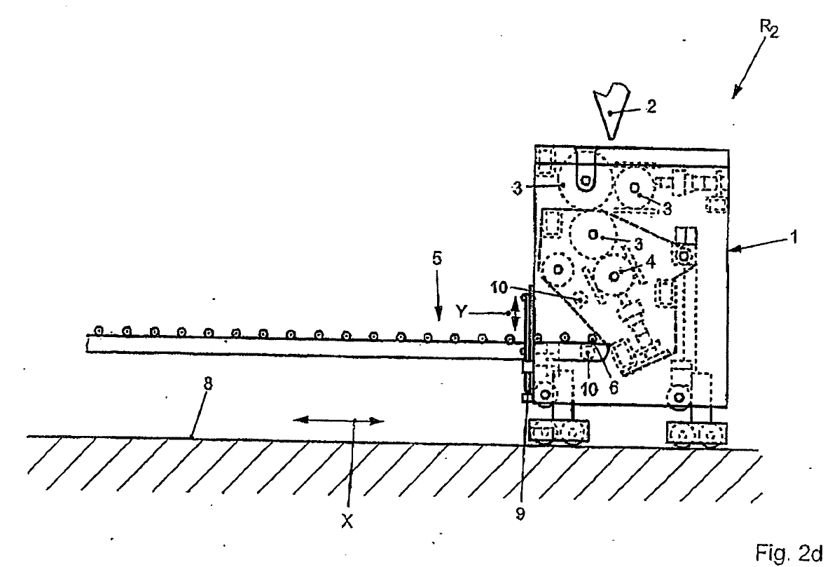

In a further exemplary embodiment of the present invention according to FIG. 2a, a device R₂ is shown which corresponds approximately to the kind named in the introduction. The difference here is that in respect of its displacement capability, the roller conveyor 5 can be directly driven in the illustrated double-arrow direction y relative to the smoothing calender 1, where an appropriately controllable drive element 9 is directly connected to or is linked to the smoothing calender 1 the displacement of the roller conveyor 5 in the double-arrow direction y.

This means that, nevertheless, the roller conveyor 5 can be moved in the illustrated double-arrow direction x, this movement taking place towards the smoothing calender 1 by means of drive elements 9 not shown here in greater detail. This also is to lie within the framework of the present invention.

In the case of the present invention, it is also important that the roller conveyor 5 and, in particular, its first roll 6 can be adapted continuously to the position of the last roll 4 of the smoothing calender 1 with regard to position, separation distance, even in operation.

Two operating circumstances are illustrated in production in FIGS. 2b and 2c, in which the roll 6 is arranged close to the roll 4 and, by means of appropriate distance-measuring devices 10—merely indicated here—which can be sensors, distance sensors or the like, a separation distance of the first roll 6 of the roller conveyor 5 to the last roll 4 of the smoothing calender 1 can be set, justified or adapted continuously. It is also possible as displayed, in particular, in the exemplary embodiment according to FIG. 2d that, for example, in the event of a crash or for servicing purposes, in relation to the last roll 4 of the smoothing calender 1, the roller conveyor 5 is lowered very quickly with a very high speed into a pit 8. This also is to lie within the framework of the present invention.

In this respect also, it is completely immaterial whether the smoothing calender 1 is constructed as a two-roll-, three-roll- or multi-roll smoothing calender where, depending upon the operational circumstances, i.e. start-up situation, operating situation or servicing situation, the last roll 4 can change its position.

Furthermore, it is important in the case of the present invention, that the position of the first roll 6 of the roller conveyor 5 is determined at all times, even in operation, in which respect different path-measurement systems and position-measurement systems can be used. Based on this position, it is possible—even when the position of this last roll 4 of the smoothing calender 1 changes—for the first roll 6 of the roller conveyor 5 to be set in position very exactly and precisely at a desired distance from the last roll 4 of the smoothing calender 1 and constantly to be carried along at the desired distance.

It is furthermore important that the roller conveyor 5 and, in particular, the first roll 6 of the roller conveyor 5 can be driven in an x- or y-direction in a controllable manner very exactly and additionally, in dependence upon the position of the last roll 4 of the smoothing calender 1. To facilitate this, the distance between the last roll 4 of the smoothing calender 1 and the first roll 6 of the roller conveyor 5 is continuously determined, measured and, if necessary, subsequently adjusted during operation.

Furthermore, it has proven to be particularly advantageous that the roller conveyor 5 can be lowered in relation to a pit 8 in order to permit servicing—or repair work together with an exchange of rolls 3, 4 of the smoothing calender 1.

In addition, a very rapid lowering of the roller conveyor 5 can be useful in order, for example, in a crash to enlarge a separation distance between the last roll 4 of the smoothing calender 1 and the first roll 6 of the roller conveyor 5 at high and substantial speed.

In addition, it has also proven to be advantageous in the present invention that the movement and, in particular, the capability for movement of the first roll 6 of the roller conveyor 5 considerably eases an automatic release and transfer onto the roller conveyor 5 of the plate produced from plastic melt, since the first roll 6 can be driven exactly over a release point of the last roll 4 of the smoothing calender 1.

1-18. (canceled)

19. A process for operating a smoothing calender (1) for plastic melts with a downstream roller conveyor (5), wherein a position of the roller conveyor (5) is aligned upon a position of a roll (4) of the smoothing calender (1), wherein a separation distance in an x- and/or y-direction from a first roll (6) of the roller conveyor (5) to the position of the last roll (4) of the smoothing calender (1) is capable of automatic adaptation, adjustment and change during operation.

20. The process as claimed in claim 19, wherein a position of the first roll (6) of the roller conveyor (5) is set upon a position of a last roll (4) of the smoothing calender (1).

21. The process as claimed in claim 19, wherein by driving the roller conveyor (5) in an x- and/or y-direction, the roller conveyor (5), in particular the first roll (6) of the roller conveyor (5) is automatically driven close to a position of a last roll (4) of the smoothing roller (1).

22. The process as claimed in claim 19, wherein the roller conveyor (5) is aligned automatically by appropriate drive elements (9) and drive agents and, in particular, the first roll (6) of the roller conveyor (5) is aligned on the last roll (4) of the smoothing calender (1).

23. The process as claimed in claim 19, wherein the exact positions of the first roll (6) of the roller conveyor (5) together with the last roll (4) of the smoothing calender (1) are acquired and by means of this, an exact control and movement of the first roll (6) of the roller conveyor (5) by movement in the x- and/or y-direction in dependence upon the movement of the last roll (4) of the smoothing calender (1) is made possible.

24. The process as claimed in claim 19, wherein, in dependence upon the position of the last roll (4) of the smoothing calender (1), even in operation, the first roll (6) of the roller conveyor (5) is continuously adapted to the position of the last roll (4) of the smoothing calender (1).

25. The process as claimed in claim 19, wherein, in operation, the separation distance between the first roll (6) of the roller conveyor (5) and the last roll (4) of the smoothing calender (1) is continuously determined and, if necessary, a differing separation distance is driven by movement of the roller conveyor (5) in the x- or y-direction relating to its desired position with respect to the smoothing calender (1).

26. The process as claimed in claim 19, wherein, to ensure an emergency opening between the last roll (4) of the smoothing calender (1) and the roller conveyor (5), the roller conveyor (5) is moved away from the last roll (4) of the smoothing calender (1) with a greater opening speed than the opening speed with which the roll (4) of the smoothing calender (1) moves towards the roller conveyor (5).

27. A device to operate a smoothing calender (1) for plastic melts with a downstream roller conveyor (5), wherein the roller conveyor (5) can be driven to a position of a roll (4) of the smoothing calender (1)), wherein a first roll (6) of the roller conveyor (5), by being driven in an x- and/or y-direction towards the last roll (4) of the smoothing calender (1), can be positioned automatically and exactly in operation.

28. The device as claimed in claim 27, wherein the roller conveyor (5) can be driven in an x- and/or y-direction towards the roller conveyor (1) and, in particular, towards a last roll (4) of the smoothing calender (1.

29. The device as claimed in claim 27, wherein the roller conveyor (5) comprises a frame (7.1, 7.2) which is provided with at least one drive element (9) in order to actively drive the roller conveyor (5) in an x- and/or y-direction in a controllable manner.

30. The device as claimed in claim 27, wherein a path-measuring system is assigned to the roller conveyor (5) in order to continuously determine precisely an exact position of the roller conveyor (5) in operation and, in particular, of a first roll (6) of the roller conveyor (5).

31. The device as claimed in claim 27, wherein, in the area of the first roll (6) of the roller conveyor (5) and/or in the area of the last roll (4) of the smoothing calender (1), at least one distance-measuring device (10) and, in particular, a separation-distance sensor is provided, in order continuously in operation to determine, adjust or change a separation distance between the last roll (4) of the smoothing calender (1) and the first roll (6) of the roller conveyor (5).

32. The device as claimed in claim 29, wherein, with respect to the frame (7.1, 7.2), the roller conveyor (5) can be driven backwards and forwards in a y-direction by drive elements (9), cylinders, spindles or the like and in a controllable manner.

33. The device as claimed in claim 29, wherein, with respect to the smoothing calender (1), the roller conveyor (5) can be actively driven backwards and forwards in an x-direction or the roller conveyor (5) can be driven in an x-direction within the frame (7.1, 7.2) by means of a drive.

34. The device as claimed in claim 27, wherein a separation distance from the first roll (6) of the roller conveyor (5) to the last roll (4) of the smoothing calender (1) is continuously measured during operation and can be adjusted by driving the roller conveyor (5).
